(19) United States
(12) Patent Application Publication
(10) Pub. No.: US 2015/0199488 A1
(43) Pub. Date: Jul. 16, 2015

(54) Systems and Methods for Interpreting Medical Information

(71) Applicant: Best Doctors, Inc., Boston, MA (US)

(72) Inventors: Kenneth H. Falchuk, Newton, MA (US); Jose A. Halperin, Brookline, MA (US); Evan Falchuk, West Newton, MA (US); Lawrence Brewster, Houston, TX (US)

(73) Assignee: BEST DOCTORS, INC., Boston, MA (US)

(21) Appl. No.: 14/203,045

(22) Filed: Mar. 10, 2014

Related U.S. Application Data
(63) Continuation-in-part of application No. 13/802,229, filed on Mar. 13, 2013.
Application No. 13/802,229 is a continuation of application No. 12/834,376, filed on Jul. 12, 2010.
Application No. 12/834,376 is a continuation of application No. 09/705,198, filed on Nov. 2, 2000, now Pat. No. 7,756,721.
Application No. 09/705,198 is a continuation-in-part of application No. 08/818,155, filed on Mar. 14, 1997, now Pat. No. 6,256,613.
(60) Provisional application No. 61/778,276, filed on Mar. 12, 2013.
(60) Provisional application No. 60/163,520, filed on Nov. 4, 1999.

(51) Int. Cl. G06F 19/00

(52) U.S. Cl. CPC G06F 19/3418; G06F 19/322

(57) ABSTRACT

Disclosed are a system and a method providing patients with access to highly ranked medical professionals. The invention identifies, ranks, and connects qualified medical experts with patients and their families across the globe. Additionally, the invention disclosed herein provides a personal, compassionate and comprehensive system and method to ensure that people get the best possible medical advice.

### BACKGROUND

Receiving a medical diagnosis can be a life altering event. A medical diagnosis can present emotional, physical, and financial challenges, and consequently, a medical diagnosis can drastically affect the quality of one's present and future life. When faced with a diagnosis, knowing which steps to take and identifying the right treatment plan is a challenging task. Identifying qualified physicians in an era defined by informational overflow can be an even more daunting mission.

Additionally, a definitive medical diagnosis can be elusive in clinical cases with complex symptoms. In such cases, a diagnosis can be confounded by a variety of seemingly unrelated medical symptoms, each symptom being somewhat unique. Moreover, although a medical provider in the payer's network can be specialized in performing a certain complex treatment, the patient having the medical symptom can require a different medical provider that is focused on a subset of a specialty of medicine. Unfortunately, patients do not generally have broad access to expert medical providers and information on those expert providers can be located in various parts of the country or in other countries.

### SUMMARY OF THE INVENTION

In some embodiments, the invention provides a method of requesting an interpretation of a medical record, the method comprising: a) receiving a medical record associated with a subject by a computer system; b) searching based on the medical record a database of health care providers, wherein each healthcare provider in the database is independently associated with a specialty, to provide at least one qualified health care provider, wherein the qualified health care provider is qualified to interpret the medical record, wherein the computer system comprises a processor, wherein the searching is performed by the processor; c) requesting from the qualified health care provider a requested interpretation of the medical record; d) receiving the requested interpretation of the medical record from the qualified health care provider; and e) ranking the requested interpretation against at least one alternative interpretation by a different health care provider to provide a ranking of interpretations.

In some embodiments, the invention provides a computer program product comprising a computer-readable medium having computer-executable code encoded therein, the computer-executable code adapted to be executed to implement a method comprising: a) providing a virtual health care system, wherein the virtual health care system comprises: i) an input module; ii) a database, wherein the database comprises a plurality of health care providers; iii) a search module; iv) a ranking module; v) a request module; and vi) an output module; b) receiving an electronic medical record from a user by the input module, whereupon the input module transmits information from the medical record to the search module; c) searching, based on the information, the database by the search module, whereby the search module identifies in the database a subset of health care providers associated with the information; d) ranking by the ranking module the subset of health care providers, whereby the ranking module ranks each health care provider in the subset of health care providers based on a level of association with the information to provide a set of ranked health care providers; e) requesting by the request module a requested interpretation of the medical record from at least one of the ranked health care providers; f) receiving by the request module at least one requested interpretation; g) ranking by the ranking module the received requested interpretation against at least one alternative interpretation to provide a set of ranked interpretations; and h) outputting the set of ranked interpretations via the output module.

### BRIEF DESCRIPTION OF THE FIGURES

FIG. 1 illustrates modules of an online physician community, including a manage cases module, a physician groups module, and a library of great cases module.

FIG. 2 illustrates an example architecture of an on-line profile of an expert.

FIG. 3 is a block diagram illustrating a first example architecture of a computer system that can be used in connection with example embodiments of the present invention.

FIG. 4 is a diagram illustrating a computer network that can be used in connection with example embodiments of the present invention.

FIG. 5 is a block diagram illustrating a second example architecture of a computer system that can be used in connection with example embodiments of the present invention.

FIG. 6 illustrates the typical architecture of a message received by a qualified physician with a request to interpret a medical record.

FIG. 7 illustrates an example architecture of a case description with a clinical summary presented to a qualified physician.

FIG. 8 illustrates representative modules of a case summary as presented to a qualified health care provider.

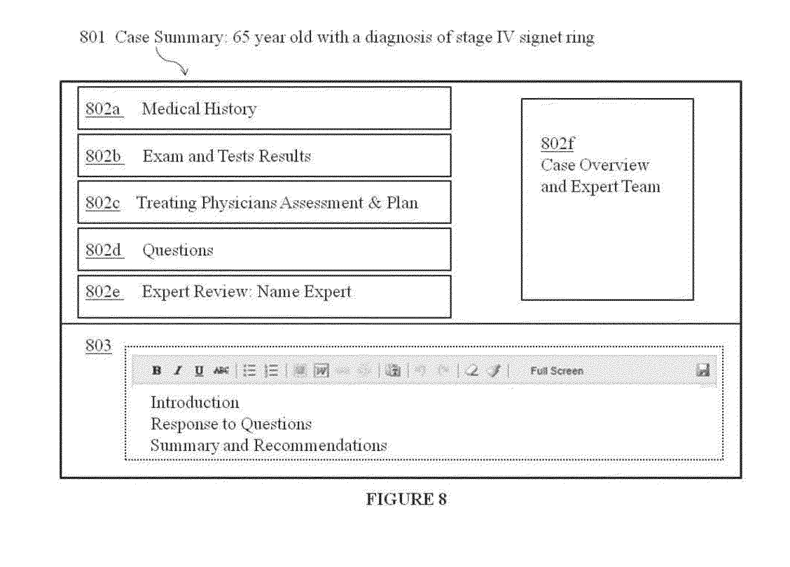

FIG. 9 illustrates representative modules of a virtual health care system comprising a physician community.

FIG. 10 illustrates representative modules available to a qualified physician to assist in case management within a virtual health care system.

FIG. 11 illustrates representative modules of a peer group community within a virtual health care system.

### DETAILED DESCRIPTION

Great challenges exist in dealing with medical diagnoses. A singular medical diagnosis for instance, can not only affect the life of a patient, but can also impact the lives of families, physicians, nurses, and respective communities. The course-of-action and types of treatments chosen in treating a disease, a syndrome or a condition have a definitive impact on the lives of many, yet few families or individuals are sufficiently equipped to handle the impact of receiving a medical diagnosis. Furthermore, at one time or another, most people receive an incorrect diagnosis or see a doctor who is mystified by their symptoms. Learning how to cope with a diagnosis can be a difficult and emotional process, learning how to cope with an incorrect diagnosis can have devastating consequences in someone's life and the lives of their loved ones.

Each year misdiagnosis cost an estimated 40,000 to 80,000 hospital deaths. Misdiagnosis can happen when physicians, often pressured by factors that can include unyielding schedules, institutional requirements, and multiple professional commitments, fail to spend adequate time learning about a patient's symptoms. Errors can also happen when physicians disregard a patient's description of their own symptoms, when physicians neglect the medical history of a patient, when physicians fail to verify the accuracy of medical test results, and when physicians neglect the possibility that they simply do not have enough information to provide a definite diagnosis, but still feel compelled to give a label for a patient's symptoms.

Provided herein is a system and a method that removes the burden of uncertainty from the shoulders of a patient, and their families, and creates a personal, compassionate, and comprehensive way to ensure that people get the best possible medical advice. The present invention helps patients and their families across the globe identify and form a relationship with the most capable physicians specializing in a plurality of fields.

Individuals and families no longer need to agonize over the prospect of collecting medical records, searching, evaluating, ranking, identifying, reviewing, contacting, and forming a relationship with the most qualified health care providers upon receiving a medical diagnosis. The system and method of the invention streamlines the process on behalf of an individual or a family while employing a kind, considerate, knowledgeable, and effective approach to medical care.

The process of interpreting medical information can start with an e-mail, a confidential call, an in-person discussion, or a plurality of other communication methods. A physician, a nurse, a medical records specialist, or administrative personnel are all members of a group that can be alerted when a new request for medical interpretation is received. Group members can interact directly with the party requesting an interpretation of a medical case. Personnel within the group can be assigned to each case, and group members can become a dedicated point-of-contact for each medical case. Group members can generate an on-line personal medical profile of the subject requesting the medical interpretation within an on-line platform of the invention. Alternatively, a subject can generate an on-line personal profile of oneself or on behalf of another.

The group receives and evaluates medical records associated with each medical case. In a preferred embodiment, subjects can submit a plurality of case records, images, and test samples to the system of the invention through a computer program product adapted to be able to receive, search, rank, categorize, and classify medical records. Alternatively, group members can collect a plurality of case records, images, and test samples on behalf of a patient. The group can systematically organize, categorize, classify, and search the medical records for information that is relevant to a diagnosis. A computer program product can systematically organize, categorize, classify, and search the medical records for information that is relevant to a diagnosis.

The invention searches a database of health care providers based on the medical record, and identifies at least one or a cohort of qualified health care providers with relevant expertise for a particular case. The invention facilitates the selection of the very best nationally-recognized physicians and/or specialists, and requests from a select group of qualified health care providers a comprehensive analysis of all medical information associated with a medical case.

Furthermore, the system and methods of the invention deliver to both the party requesting an interpretation of a medical record, and their treating physician, an expert report tailored to the case. The report serves as a clinical roadmap comprising recommendations on diagnosis and treatments. The team provided by the invention also interacts with individuals and families at major milestones to assess progress and address any new issues. Treating physicians are pleased with the new insight that expert advice can offer to a case. Patients and families can make confident decisions regarding treatment options, and feel reassured by having access to ranked physicians. The process comprises a personal, pragmatic, and compassionate method to ensure individuals and families are finding the best available care.

Furthermore, patients and families do not have to travel or deal with the healthcare system on their own. Within the convenience of their home, individuals and families can receive the answers they need and the peace of mind they seek. This aspect of the invention can alleviate many barriers to the delivery of optimal patient care in some settings faced with scarcity of physicians, limited availability of specialty physicians, geographic isolation, distance, limited access to care, resource limitations, technology, and financial challenges. The invention offers a comprehensive and analytical approach to understanding and addressing the need of many communities and the problems facing both individuals receiving a medical diagnosis, and physicians providing medical interpretations.

### Requesting an Interpretation of a Medical Record.

The system and methods of the invention provide an in-depth interpretation of a medical diagnosis and treatment plan by a qualified health care provider. A medical interpretation can be requested on behalf of a subject. A subject can be, for example, an elderly adult, an adult, an adolescent, a pre-adolescent, a child, a toddler, or an infant.

The method for interpreting a health care request can commence when a system of the invention receives a medical record associated with a subject by a computer system. A medical record can be received by the invention, for example, when a subject provides information to an on-line personal medical profile. An on-line personal medical profile of the subject can comprise a plurality of medical records, for example, exam and test results, medical history, and an assessment and treatment regimen by a treating physician. In some embodiments, the medical record comprises a preliminary diagnosis. In some embodiments, the medical record is received via a health request from the subject.

The computer system searches based on the medical record a database of health care providers. In some embodiments, the search identifies a plurality of qualified health care providers, and each qualified health care provider is ranked to provide a ranked set of qualified health care providers ordered from a highest rank to a lowest rank. The system and methods of the invention can request from a qualified health care provider an interpretation of the medical record, and the qualified health care provider is given the opportunity to review each case thoroughly. In some embodiments, the qualified health care provider has an expertise associated with the medical record. For example, a subject who has been grappling with lower back pain can provide a magnetic resonance imaging (MRI) indicating spine degenerative changes, mild disc buldges, and borderline nerve changes. The system and methods of the invention can request an interpretation of the medical record from a neurosurgeon who is an expert in spinal instability.

The medical expertise of a health care provider can be used by the system and methods of the invention in searching a database of health care providers and identifying at least one qualified health care provider qualified to interpret the medical record. In some embodiments, the requested interpretation can be ranked based on a level of expertise of the health care provider. For example, a subject with symptoms including shortness of breath, leg swelling, and exercise intolerance can be suspected to be at risk for congestive cardiac failure. Echocardiographs and blood tests can be used by a treating physician to diagnose congestive cardiac failure. A treating physician of the subject can recommend a treatment that includes surgery to implant a medical device, such as a pacemaker or ventricular assist device, in the patient's heart. Prior to committing to surgery, the subject can seek a second medical opinion. The subject can utilize the system and method of the invention to submit a request for an interpretation of the subject's medical record. The invention can, for example, rank the interpretation based on a minimum level of expertise required to provide the interpretation, such as expertise in cardiac surgery, general cardiology, and cardiac electrophysiology.

In some embodiments the requested interpretation is based on virtual collaboration among the qualified health care provider and at least an additional health care provider. For example, a subject with a diagnosis of congestive cardiac failure can receive an expert interpretation that comprises a virtual collaboration between a qualified cardiac electrophysiology specialist reviewing medical media associated with the diagnosis, such as echocardiographs, and a cardiac surgeon, who is providing an expert opinion on the best surgical procedure, in this example implanting a pacemaker or a ventricular assist device. In some embodiments, the qualified health care provider and the additional health care provider are anonymous to one another.

A plurality of interpretations of a medical record can be evaluated by a method of the invention. An interpretation of a medical record can be, for example, a first interpretation by a treating physician comprised within the request for an interpretation. An interpretation can, for example, be provided by at least one qualified health care provider associated with the invention. Interpretations can, for example, be provided by multiple qualified health care providers associated with the invention. In some embodiments, the invention identifies a plurality of qualified health care providers, and each qualified health care provider of the plurality is ranked to provide a ranked set of qualified health care providers ordered from a highest rank to a lowest rank.

A plurality of ranking criteria can be used to identify a ranked set of qualified physicians. For example, the invention can search a database of health care providers based on a request comprising MRI records indicating debilitating back, head, and neck degeneration. The invention can identify a plurality of neurosurgeons as qualified health care providers. The invention can rank the neurosurgeons based on the length of the careers, the familiarity of the neurosurgeon with MRI records similar to the record comprised within the request, and/or the geolocation of the neurosurgeon. In some embodiments, requesting an interpretation of a medical record comprises querying the qualified health care providers in the ranked set in an order beginning with the qualified health care provider with the highest rank. In some embodiments, requesting an interpretation of a medical record comprises querying the qualified health care providers in the ranked set in a random order.

Criteria used to identify a ranked set of physicians can be found directly or indirectly in the medical record. For example, a pediatric subject diagnosed with structural malformation of the heart can provide a medical record comprising a cardiac computed tomography (CT) with the request for an interpretation. The invention can search the medical record and the invention can note that the cardiac CT highlights the heart's anatomy and coronary circulation. The invention can search a database of health care providers based on information directly found on the medical record, such as “cardiac CT”, and “pediatric cardiology.” The invention can search a database of health care providers based on information indirectly found on the medical record, for example, the invention can search for “cardiovascular surgeons” as qualified health care providers based on a medical record comprising a cardiac CT.

In some aspects, the invention provides a system and a method for identifying a qualified physician based on the description of a condition. In some embodiments, the invention further comprises searching a database of medical resources based on information in the medical record, thereby identifying a relevant resource, and providing the relevant medical resource to the qualified health care provider upon requesting the requested interpretation.

The system and method of the invention can receive a plurality of requested interpretations from a plurality of qualified health care providers. A plurality of criteria can be combined to provide a ranking of interpretations of a medical record. The invention can, for example, rank all interpretations that recommend surgery as a proposed treatment based on the qualifications of the physician providing the interpretation. The invention can, for example, rank all interpretations based on the order in which the requested interpretation of the medical record is received from a qualified health care provider.

The system and method of the invention can request a plurality of interpretations from a plurality of qualified health care providers. Qualified providers can accept the request to provide an interpretation of a medical record. Qualified providers can deny the request to provide an interpretation of a medical record. The invention can for example, request an interpretation of a medical record from a qualified health care provider after at least one other qualified health care provider replied to the request affirmatively.

A subject, a physician, a nurse, a medical records specialist, or administrative personnel can seek a second opinion on an interpretation provided by a qualified health care provider. In some embodiments, the method for requesting an interpretation of a medical record further comprises soliciting from a physician a second opinion of the ranking of interpretations.

In some embodiments, an authorized user can be granted access to the ranking of interpretations provided by the invention. Users of the system can be, for example, a custodian of the subject, a health care provider, a treating physician, a specialist, a family member, a friend, or the subject.

An interpretation of a medical record can comprise, for example, a diagnosis, a treatment recommendation, a review of an existing diagnosis, a review of a treatment recommendation to provide a second opinion diagnosis, a referral to a specialist, and/or a review of a clinical case by an expert.

### Virtual Health Care System.

Another aspect of the present invention relates to a method for providing a virtual health care system. A virtual health care system can comprise an on-line community wherein qualified health care providers can manage and/or be associated with clinical cases they are associated with, participate in physician groups, participate in professional networking groups, and access a library of notable cases shared by their peers. A virtual health care system can comprise a computer-readable medium having computer executable code adapted to be executed to implement a method comprising providing a virtual health care system

A virtual health care system can comprise an input module, a plurality of databases, structured in a plurality of different architectures, comprising a plurality of health care providers, a search module, a ranking module, a request module, and an output module. In some embodiments, a virtual health care system comprises an on-line community of physicians. In some embodiments, the online community comprises a subset of physicians.

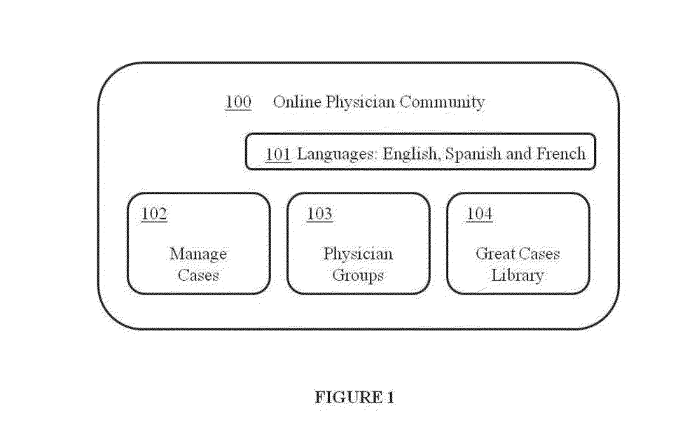

A health care provider can access an on-line physician community (FIG. 1, 100).

The qualified physician can, for example, choose a preferred language for viewing the website 101. The qualified physician can access links for managing cases 102, viewing and participating in physician groups 103, and viewing and participating in a library assembling noteworthy medical cases 104.

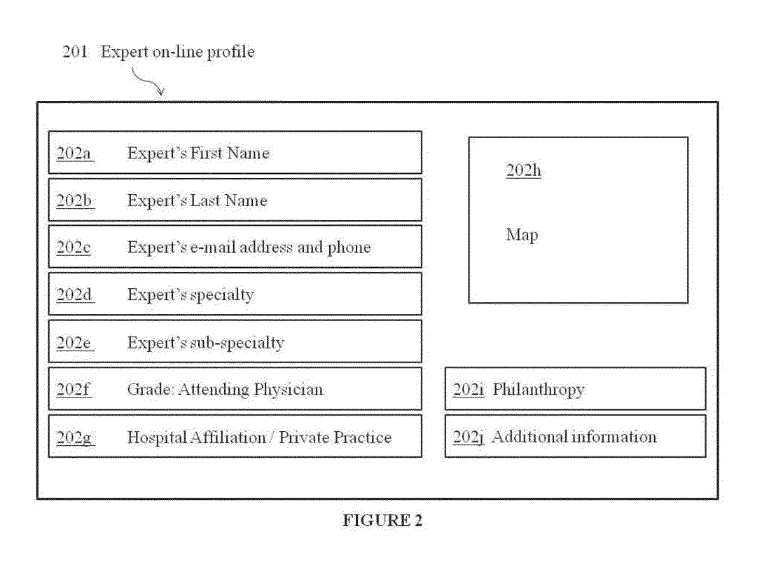

A health care provider that is associated with an on-line physician community within a virtual health care system can be identified within the system of the invention by an expert on-line profile as illustrated in FIG. 2, 201. The expert on-line profile can comprise information such as the expert's first name 202a, the expert's last name 202b, the expert's e-mail address and phone number 202c, the expert's specialty 202d, the expert's sub-specialty 202e, the expert's grade 202f, such as the expert's title as an attending physician, chair of a department, or chief or surgery, the expert's affiliation 202g, such as the expert's affiliation with a hospital or a private practice, a map 202h of a preferred physical professional address of the expert, the expert's involvement in philanthropic activities 202i, and additional information provided by the expert 202j.

The system and method of the invention can receive personal health information for entry into an on-line subject profile. Personal health information of a subject can comprise general information about the subject, medical history, medical encounter history, existing disease information, and pertinent information associated with recent activities of a subject. Non-limiting examples of personal health information include, age, sex, blood type, family history, height, weight, diet, BMI, risk for diabetes mellitus (DM) and pre-DM, family history, risk for pre-hypertension (HTN), systolic and diastolic blood pressure measurements, salt intake, microscopic urinalysis, proteinuria, serum blood urea nitrogen, creatinine levels, calcium levels, thyroid-stimulating hormone (TSH) levels, blood glucose, HDL and LDL cholesterol levels, triglycerides, hematocrits, electrocardiograms, and/or chest radiographs, metabolic syndrome, hyperlipidemia, risk of infection, decreased immune system, compromised circulation, compromised skin integrity, repeated contact with contagious agents, cancer screening, CAT scans, and MRIs.

A subject can contribute to an on-line personal medical profile of the subject within a virtual health care system on a regular basis. A subject can, for example, access an on-line profile to update information relevant to the request for a medical interpretation, such as a symptom. A subject can, for example, access an on-line profile to upload recent medical files.

The system and method of the invention can receive a request for interpretation of a medical record associated with an on-line profile of a subject. A virtual health care system can associate a plurality of qualified health care providers with a received request for the interpretation of a medical record. A virtual health care system can rank a list of qualified health care providers based on a level of association with the information provided in the medical record. A level of association can be, for example, a set of professional qualifications required for the interpretation of the medical record, such as board qualification, surgical expertise, area of expertise, length of career, reputation among peers, and prior achievement(s). A virtual health care system can prioritize the ranking of a request as, for example, urgent, time-sensitive, critical, trivial, and requiring multiple areas of expertise.

A virtual health care system of the invention provides a database of medical resources and a medical resource search module to qualified health care providers. A virtual health care system can comprise an effective method for requesting a medical interpretation from a qualified health care provider. A virtual health care system can categorize and associate a request for a medical interpretation submitted by a subject based on the information comprised within a subject on-line profile. A virtual health care system can associate a subset of health care providers with a request for an interpretation based on, for example, a specialty or a geographic location associated with the subset of health care providers. A virtual health care system of the invention can rank a plurality of health care providers in regards to, for example, the health care provider's qualifications (including board qualifications), area of expertise, length of career, reputation among peers, and prior achievement(s).

A virtual health care system can search, based on the information comprised within the request for a medical interpretation, a database that identifies a subset of health care providers associated with the information. In some embodiments, a health care provider in the subset of health care providers can be identified based on, for example, a referral from a member of the virtual community, the number of cases wherein the provider reviewed medical records that are similar to medical records associated in a new request for medical interpretation, and/or hospital affiliation. In some embodiments, a health care provider in the subset of health care providers is independently associated with the information based on a specialty. For example, a hematologist can be identified in the database comprising a subset of health care providers as a physician with expertise associated in treating blood disorders.

The system of the invention can search a plurality of databases of medical resources, constructed with a plurality of architectures, and supported by a plurality of different data management systems, including, for example: a) graph databases; b) hypermedia databases; c) hypertext databases; d) in-memory database; e) document-oriented databases, wherein the database stores, retrieves, and manages document-oriented, or semi-structured data, for example, a subject's medical history can be accessed by the system of the invention from a document-oriented database; f) cloud databases, wherein the database and a data management system reside remotely; g) data warehouses, wherein the data warehouses archive data from operational databases and data can undergo transformation on their way into the warehouse, getting summarized, and reclassified; h) active databases, wherein the database can respond to conditions both inside and outside the database in real-time; i) distributed databases, wherein the database includes a plurality of modules that can include modules shared by multiple sites, and modules specific to one site and used only locally in that site, for example a database used and shared by local medical-groups, departments at regional hospitals, branch hospitals, and other hospital management locations; j) embedded databases, wherein the database is a database management system which is tightly integrated with application software that requires access to stored data in a way that the database management system is hidden from the application's end-user, for example, the invention can receive medical records from a medical records platform that is a database management system; k) end-user databases, wherein the end-user database consists of data developed by individual end-users, examples of these are collections of documents, spreadsheets, presentations, multimedia, and other files developed by the subject; l) federated databases and multi-databases, wherein a federated database is an integrated database that comprises several distinct databases, each with its own data management system; m) knowledge-based databases, wherein the database provides the tools for the computerized collection, organization, and retrieval of knowledge, for example, data representing collections of problems and related experiences; n) operational databases, wherein the database process relatively high volumes of updates including medical media; o) spatial databases, wherein the database can store data with multidimensional features; p) temporal databases, wherein the database includes built-in time aspects, examples include a valid-time and behavior occurrence-time; and q) unstructured-databases, wherein the database is constructed to store in a manageable and protected way diverse objects that do not fit naturally and conveniently in common databases, including, for example, email messages, documents, journals, and multimedia objects.

A virtual health care system can, based on the information comprised within the request for a medical interpretation, rank a plurality of health care providers that are associated with the request. A virtual health care system can, based on the information comprised within the request for a medical interpretation, rank a plurality of interpretations provided by qualified health care providers. In some embodiments, a system of the invention can correlate the ranked set of qualified health care providers with the ranked set of interpretations provided.

A system and a method of the invention can provide access to the medical record and the requested interpretation of the same to an on-line community of physicians over a virtual health care system of the invention.

### Health Care Providers.

A qualified health care provider can be, for example, an acupuncturist, an addiction psychiatrist, an adolescent medicine specialist, an allergist, an immunologist, an allopathic physician, an anatomic and clinical pathology specialist, an anatomic pathology specialist, an anesthesiologist, an athletic trainer, an audiologist, an ayurvedic medicine specialist, a bariatric medicine specialist, a bariatric surgery specialist, a blood banking transfusion medicine specialist, a cardiac electrophysiologist, a cardiac surgeon, a cardiac surgery specialist, a cardiologist, a certified diabetes educator, a certified nursing assistant, a chemical pathologist, a Chinese medicine specialist, a chiropractor, a clinical and laboratory immunology specialist, a clinical biochemical genetics specialist, a clinical cardiac electrophysiology specialist, a clinical cytogenetics specialist, a clinical genetics specialist, a clinical lipidology specialist, a clinical neurophysiology specialist, a clinical nurse specialist, a clinical pathology specialist, a colorectal surgeon, a colon and rectal specialist, a coroner, a counselor, a critical care medicine, a critical care surgery, a cytopathologist, a cytotechnologist, a dental hygienist, a dentist, a dermatologist, a dermatopathologist, a developmental pediatrician, a diabetologist, a dietician, an ear-nose-throat specialist, an emergency medical technician, an emergency medicine specialist, an endocrinologist, an endodontist, an eye specialist, a family practitioner, a fertility specialist, a forensic pathologist, a forensic psychiatrist, a gastroenterologist, a gastrointestinal surgeon, a geneticist, a genetic counselor, a geriatric medicine specialist, a geriatric psychiatrist, a gynecologist, a gynecological oncologist, a hearing/speech specialist, a hematologist, a hepatologist, a holistic medicine specialist, a hospice care and palliative medicine specialist, a homeopathic specialist, an immunologist, an immunopathologist, an infectious disease specialist, an internist, an iridologist, a kinesiotherapist, a laryngologist, a maxillofacial surgeon, a medical assistant, a medical examiner, a medical geneticist, a medical oncologist, a medical toxicologist, a midwife, a molecular genetic pathologist, a mental health specialist, a neonatal-perinatal specialist, a nephrologist, a neurologist, a neuroradiologist, a neurosurgeon, a nuclear medicine specialist, a nurse, a nurse practioner, an obstetrician, an oncologist, an ophthalmologist, an optometrist, an oral pathology specialist, an oral surgeon, an orthodontist, an orthopedic specialist, an otolaryngologist, an otologist, a pain management specialist, a pathologist, a pediatrician, a perfusionist, a periodontist, a physical therapist, a plastic surgeon, a podiatrist, a proctologist, a prosthetic specialist, a psychiatrist, a public health specialist, a pulmonologist, a radiologist, a reproductive endocrinologist and infertility specialist, a rheumatologist, a rhinologist, a sleep disorder specialist, a sonographer, a speech specialist, a surgeon, a thoracic specialist, a transplant specialist, a urogynecologist, a urologist, a vascular specialist, and a vascular surgeon.

### Medical Records.

The present invention pertains to a system and a method of requesting an interpretation of a medical record. In some embodiments, a medical record associated with a subject is received by a computer system, and the computer system utilizes information comprised within the medical record to search a database of healthcare providers.

A medical record can comprise one or a compilation of documents describing medical information of a subject. A medical record can comprise the complete medical history and care of a subject across a period of time, or a medical record can comprise a single event in a patient's medical history. A medical record can describe major and minor diseases, a surgical history, an obstetric history, medications and medical allergies, family history, social history, habits, immunization history, growth and developmental history.

A subject's medical record can refer to a medical history of what has happened to the subject since birth. For example, medical history can be a record of diseases, major and minor illnesses, and/or growth landmarks. A medical record can describe a chief complaint, a history of the present illness, a physical examination, an assessment of a clinical case, and a proposed course of action to treat a condition. In some embodiments, a medical record received by the system and method of the invention comprises a preliminary diagnostic. In some embodiments, interpreting a medical record comprises a review of the record to provide a diagnosis.

A subject's medical history can comprise surgical history. Surgical history can describe surgery performed on a subject, for example, dates of operations, operative reports, and/or the detailed narrative of what a surgeon performed.

Medical history can comprise obstetric history. Obstetric history can comprise prior pregnancies, pregnancy outcomes, and/or pregnancy complications. In some embodiments, medical history can comprise medications and medical allergies, for example, a subject's current and previous medications and/or medical allergies.

In some embodiments, medical history can comprise family history. Family history can comprise one or more lists of immediate family members' health status, for example, causes of death, diseases common in the subject's family or found only in one sex or the other, and/or a pedigree chart.

In some embodiments, medical history can comprise social history. Social history can comprise one or more chronicles of a subject's human interactions, for example, relationships of the subject, a subject's careers, trainings, schooling, and/or religious training. In some embodiments, social history can provide information regarding community relationship support that the subject can expect for a particular disease, provide information that can explain one or more behaviors of a subject in relation to one or more illnesses or losses, and/or can provide information to aid in a determination of one or more causes of one or more illnesses, for example, occupational exposure to asbestos. In some embodiments, medical history can comprise habits which can impact a subject's health. Habits which impact health can comprise, for example, tobacco use, alcohol intake, exercise, diet, sexual habits, and/or sexual orientation. In some embodiments, medical history can comprise immunization history. Immunization history can comprise a history of a subject's vaccinations, and/or blood tests providing immunity data.

In some embodiments, medical history can comprise one or more growth charts and developmental history. For example, if the subject is a child or teenager, growth charts and developmental history can comprise one or more charts documenting a subject's growth and/or a comparison to data of other subjects of the same age. In some embodiments, growth charts and developmental history can provide information for the cause of an illness because many diseases and social stresses can affect growth and development of a subject. In some embodiments, growth charts and developmental history can comprise information regarding a child's behavior, for example, timing of talking, and/or timing of walking, and/or a comparison to other children of the same age.

Pharmacy medical records (PMR) can relate to records pertaining to a subject's pharmacological history. In some embodiments, pharmacological history can comprise a subject's prescription history, current prescription regimen, and side effect information, for example, dosage information, length of time a subject has been taking a prescription, and other drugs known to cause negative side effects with a subject's current prescription regimen.

Electronic Medical Records (EMRs) can relate to records obtained and stored by a subject's doctor, clinician, insurance company, hospital and/or other facilities where a subject is a patient. In some embodiments, a health care provider can include a medical doctor, a dentist, an optometrist, a therapist, a chiropractor, and anyone who provides healthcare services to the subject. Electronic medical records (EMR) can comprise, for example, CAT scans, MRIs, ultrasounds, blood glucose levels, diagnoses, allergies, lab test results, EKGs, medications, daily charting, medication administration, physical assessments, admission nursing notes, nursing care plans, referrals, present and past symptoms, medical history, life style, physical examination results, tests, procedures, treatments, medications, discharges, history, diaries, problems, findings, immunizations, admission notes, on-service notes, progress notes, preoperative notes, operative notes, postoperative notes, procedure notes, delivery notes, postpartum notes, and discharge notes.

In some embodiments, data delivery of an expert review of a medical record is compliant with the Health Insurance Portability and Accountability Act (HIPAA) standards.

In some embodiments, medical records received by the invention can be available for peer-review within a virtual health care system comprising an on-line community with access to the medical record. A virtual health care system can comprise a database of medical resources and a medical resource search module. Qualified health care providers, including broader groups of physicians, such as a group of oncologists, and a subset of physicians, such as a group of neurology surgical oncologists, can have access to an on-line portal within an on-line community of the invention. The on-line portal can provide health care providers with access to a database of medical resources, a library of noteworthy cases within the community, an on-line community of colleagues, and access to medical records pertaining to a medical case the provider is associated with.

In some embodiments, the on-line community within the virtual health care system further comprises a medical imaging module. The medical imaging module can provide, for example, physicians, nurses, and specialist's access to medical images associated with the medical record. The medical images within the medical imaging module can be associated with at least one text description(s) detailing an existing reading or interpretation of the medical media. The medical images can be deprived of any prior reading or interpretation of the medical media.

In some aspects, the invention comprises a system and a method for understanding a medical record comprising the description of a condition. Qualified physicians that provide, for example, clear, logical, fact-based, and comprehensible explanations of a clinical case can be further queried in regards to the same case, or in regards to similar cases. In some embodiments, whereupon receiving the requested interpretation of a medical record from a qualified health care provider, the computer system of the invention places the qualified health care provider on a queue to receive future health care requests associated with the condition.

### Medical Diagnosis.

Medical diagnosis can refer to both the process of attempting to determine or attempting to identify a possible disease, disorder, or condition, and to the diagnostic opinion reached by this process. A medical diagnosis can indicate either degree of abnormality on a continuum or a medical diagnosis can indicate abnormality in a classification. A medical diagnosis can comprise a brief summation or an extensive evaluation of a patient's medical record. A medical diagnosis can describe a condition that requires surgery as a preferred treatment option.

A medical diagnosis can refer, for example, to any disease, syndrome or condition that causes pain, irregularity, dysfunction, physical, emotional, or psychological distress, social problems, and/or death to the person afflicted. Conditions can include injuries, disabilities, disorders, syndromes, infections, isolated symptoms, deviant behaviors, atypical variations of normal cellular structure and function, atypical variations of normal bodily structure and function, pathogenic diseases, deficiency diseases, hereditary diseases, and physiological disease.

A medical diagnosis can comprise naming a disease, lesion, dysfunction or disability. A medical diagnosis can be a management-naming or prognosis-naming exercise. A medical diagnosis can be uncertain and provisional. In some embodiments, a medical diagnosis is comprised within the interpretation of the medical record. A medical diagnosis can, for example, provide a subject with a recommendation of a therapeutic intervention.

A medical diagnosis can be, for example, cancer. Non-limiting examples of cancers that can be associated with a medical record by the system of the invention include: acute lymphoblastic leukemia, acute myeloid leukemia, adrenocortical carcinoma, AIDS-related cancers, AIDS-related lymphoma, anal cancer, appendix cancer, astrocytomas, basal cell carcinoma, bile duct cancer, bladder cancer, bone cancers, brain tumors, such as cerebellar astrocytoma, cerebral astrocytoma/malignant glioma, ependymoma, medulloblastoma, supratentorial primitive neuroectodermal tumors, visual pathway and hypothalamic glioma, breast cancer, bronchial adenomas, Burkitt lymphoma, carcinoma of unknown primary origin, central nervous system lymphoma, cerebellar astrocytoma, cervical cancer, childhood cancers, chronic lymphocytic leukemia, chronic myelogenous leukemia, chronic myeloproliferative disorders, colon cancer, cutaneous T-cell lymphoma, desmoplastic small round cell tumor, endometrial cancer, ependymoma, esophageal cancer, Ewing's sarcoma, germ cell tumors, gallbladder cancer, gastric cancer, gastrointestinal carcinoid tumor, gastrointestinal stromal tumor, gliomas, hairy cell leukemia, head and neck cancer, heart cancer, hepatocellular (liver) cancer, Hodgkin lymphoma, Hypopharyngeal cancer, intraocular melanoma, islet cell carcinoma, Kaposi sarcoma, kidney cancer, laryngeal cancer, lip and oral cavity cancer, liposarcoma, liver cancer, lung cancers, such as non-small cell and small cell lung cancer, lymphomas, leukemias, macroglobulinemia, malignant fibrous histiocytoma of bone/osteosarcoma, medulloblastoma, melanomas, mesothelioma, metastatic squamous neck cancer with occult primary, mouth cancer, multiple endocrine neoplasia syndrome, myelodysplastic syndromes, myeloid leukemia, nasal cavity and paranasal sinus cancer, nasopharyngeal carcinoma, neuroblastoma, non-Hodgkin lymphoma, non-small cell lung cancer, oral cancer, oropharyngeal cancer, osteosarcoma/malignant fibrous histiocytoma of bone, ovarian cancer, ovarian epithelial cancer, ovarian germ cell tumor, pancreatic cancer, pancreatic cancer islet cell, paranasal sinus and nasal cavity cancer, parathyroid cancer, penile cancer, pharyngeal cancer, pheochromocytoma, pineal astrocytoma, pineal germinoma, pituitary adenoma, pleuropulmonary blastoma, plasma cell neoplasia, primary central nervous system lymphoma, prostate cancer, rectal cancer, renal cell carcinoma, renal pelvis and ureter transitional cell cancer, retinoblastoma, rhabdomyosarcoma, salivary gland cancer, sarcomas, skin cancers, skin carcinoma merkel cell, small intestine cancer, soft tissue sarcoma, squamous cell carcinoma, stomach cancer, T-cell lymphoma, throat cancer, thymoma, thymic carcinoma, thyroid cancer, trophoblastic tumor (gestational), cancers of unkown primary site, urethral cancer, uterine sarcoma, vaginal cancer, vulvar cancer, Waldenström macroglobulinemia, and Wilms tumor.

A medical diagnosis can identify, for example, a genetic disorder. Non-limiting examples of genetic disorders include: undiagnosed conditions, cystic fibrosis, Duchenne muscular dystrophy, Haemochromatosis, Tay-Sachs disease, Prader-Willi syndrome, Angelman syndrome, neurofibromatosis, phenylketonuria, Canavan disease, Coeliac disease, Acid beta-glucosidase deficiency, Gaucher, Charcot-Marie-Tooth disease, color blindness, Cri du chat, polycystic kidney disease, acrocephaly, familial adenomatous polyposis, adrenal gland disorders, amyotrophic lateral sclerosis (ALS), Alzheimer's disease, Parkinson's disease, anemia, ataxia, ataxia telangiectasia, autism, bone marrow diseases, Bonnevie-Ullrich syndrome, brain diseases, von Hippel-Lindau disease, congenital heart disease, Crohn's disease, dementia, myotonic dystrophy, Fabry disease, fragile X syndrome, galactosemia, genetic emphysema, retinoblastoma, Pendred syndrome, Usher syndrome, Wilson disease, neuropathies, Huntington's disease, immune system disorders, gout, X-linked spinal-bulbar muscle atrophy, learning disabilities, Li-Fraumeni syndrome, lipase D deficiency, Lou Gehrig disease, Marfan syndrome, metabolic disorders, Niemann-Pick, Noonan syndrome, Osteopsathyrosis, Peutz-Jeghers syndrome, Pfeiffer syndrome, porphyria, progeria, Rett syndrome, tuberous sclerosis, speech and communication disorders, spinal muscular atrophy, Treacher Collins syndrome, trisomies, and monosomies.

### Computer Architectures.

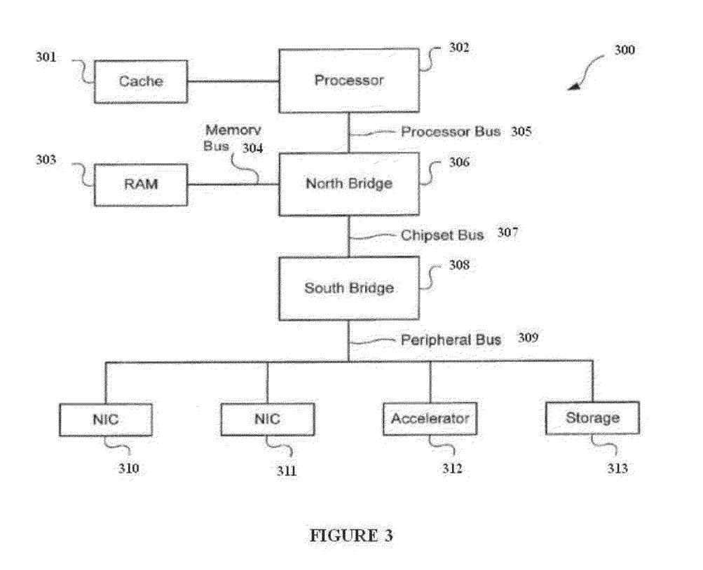

Various computer architectures are suitable for use with the invention. FIG. 3 is a block diagram illustrating a first example architecture of a computer system 300 that can be used in connection with example embodiments of the present invention. As depicted in FIG. 3, the example computer system can include a processor 302 for processing instructions. Non-limiting examples of processors include: Intel Core i7™ processor, Intel Core i5™ processor, Intel Core i3™ processor, Intel Xeon™ processor, AMD Opteron™ processor, Samsung 32-bit RISC ARM 1176JZ(F)-S v1.0™ processor, ARM Cortex-A8 Samsung S5PC100™ processor, ARM Cortex-A8 Apple A4™ processor, Marvell PXA 930™ processor, or a functionally-equivalent processor. Multiple threads of execution can be used for parallel processing. In some embodiments, multiple processors or processors with multiple cores can be used, whether in a single computer system, in a cluster, or distributed across systems over a network comprising a plurality of computers, cell phones, and/or personal data assistant devices.

As illustrated in FIG. 3, a high speed cache 301 can be connected to, or incorporated in, the processor 302 to provide a high speed memory for instructions or data that have been recently, or are frequently, used by processor 302. The processor 302 is connected to a north bridge 306 by a processor bus 305. The north bridge 306 is connected to random access memory (RAM) 303 by a memory bus 304 and manages access to the RAM 303 by the processor 302. The north bridge 306 is also connected to a south bridge 308 by a chipset bus 307. The south bridge 308 is, in turn, connected to a peripheral bus 309. The peripheral bus can be, for example, PCI, PCI-X, PCI Express, or other peripheral bus. The north bridge and south bridge are often referred to as a processor chipset and manage data transfer between the processor, RAM, and peripheral components on the peripheral bus 309. In some architectures, the functionality of the north bridge can be incorporated into the processor instead of using a separate north bridge chip.

In some embodiments, system 300 can include an accelerator card 312 attached to the peripheral bus 309. The accelerator can include field programmable gate arrays (FPGAs) or other hardware for accelerating certain processing.

Software and data are stored in external storage 313 and can be loaded into RAM 303 and/or cache 301 for use by the processor. The system 300 includes an operating system for managing system resources; non-limiting examples of operating systems include: Linux, Windows™, MACOS™, BlackBerry OS™, iOS™, and other functionally-equivalent operating systems, as well as application software running on top of the operating system.

In this example, system 300 also includes network interface cards (NICs) 310 and 311 connected to the peripheral bus for providing network interfaces to external storage, such as Network Attached Storage (NAS) and other computer systems that can be used for distributed parallel processing.

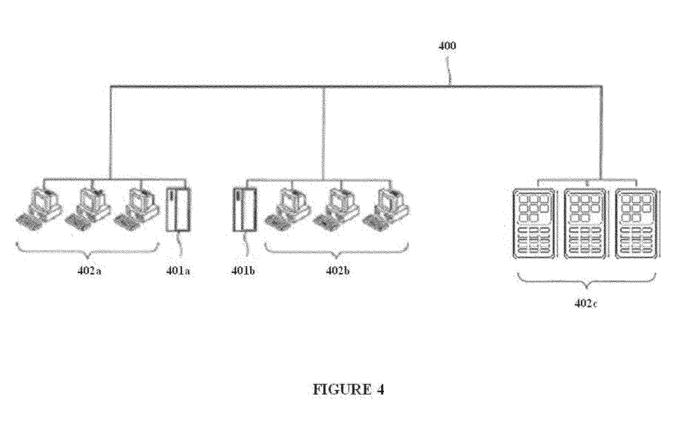

FIG. 4 is a diagram showing a network 400 with a plurality of computer systems 402a, and 402b, a plurality of cell phones and personal data assistants 402c, and Network Attached Storage (NAS) 401a, and 401b. In some embodiments, systems 402a, 402b, and 402c can manage data storage and optimize data access for data stored in Network Attached Storage (NAS) 401a and 402b. A mathematical model can be used for the data and be evaluated using distributed parallel processing across computer systems 402a, and 402b, and cell phone and personal data assistant systems 402c. Computer systems 402a, and 402b, and cell phone and personal data assistant systems 402c can also provide parallel processing for adaptive data restructuring of the data stored in Network Attached Storage (NAS) 401a and 401b. FIG. 4 illustrates an example only, and a wide variety of other computer architectures and systems can be used in conjunction with the various embodiments of the present invention. For example, a blade server can be used to provide parallel processing. Processor blades can be connected through a back plane to provide parallel processing. Storage can also be connected to the back plane or as Network Attached Storage (NAS) through a separate network interface.

In some embodiments, processors can maintain separate memory spaces and transmit data through network interfaces, back plane, or other connectors for parallel processing by other processors. In some embodiments, some or all of the processors can use a shared virtual address memory space.

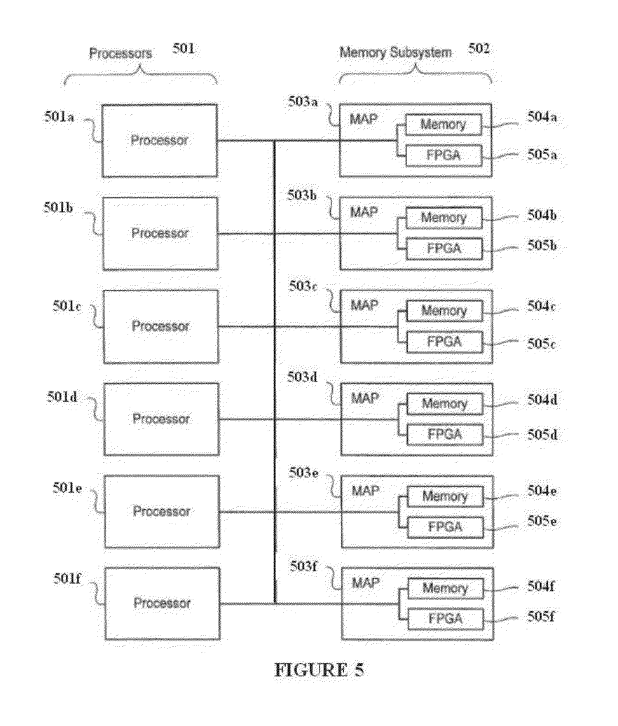

FIG. 5 is a block diagram of a multiprocessor computer system using a shared virtual address memory space. The system includes a plurality of processors 501a-f that can access a shared memory subsystem 502. The system incorporates a plurality of programmable hardware memory algorithm processors (MAPs) 503a-f in the memory subsystem 502. Each MAP 503a-f can comprise a memory 504a-f and one or more field programmable gate arrays (FPGAs) 505a-f. The MAP provides a configurable functional unit and particular algorithms or portions of algorithms can be provided to the FPGAs 505a-f for processing in close coordination with a respective processor. In this example, each MAP is globally accessible by all of the processors for these purposes. In one configuration, each MAP can use Direct Memory Access (DMA) to access an associated memory 504a-f, allowing it to execute tasks independently of, and asynchronously from, the respective microprocessor 501a-f. In this configuration, a MAP can feed results directly to another MAP for pipelining and parallel execution of algorithms.

The above computer architectures and systems are examples only, and a wide variety of other computer, cell phone, and personal data assistant architectures and systems can be used in connection with example embodiments, including systems using any combination of general processors, co-processors, FPGAs and other programmable logic devices, system on chips (SOCs), application specific integrated circuits (ASICs), and other processing and logic elements. Any variety of data storage media can be used in connection with example embodiments, including random access memory, hard drives, flash memory, tape drives, disk arrays, Network Attached Storage (NAS) and other local or distributed data storage devices and systems.

In example embodiments, the computer system can be implemented using software modules executing on any of the above or other computer architectures and systems. In other embodiments, the functions of the system can be implemented partially or completely in firmware, programmable logic devices such as field programmable gate arrays (FPGAs) as referenced in FIG. 5, system on chips (SOCs), application specific integrated circuits (ASICs), or other processing and logic elements. For example, the Set Processor and Optimizer can be implemented with hardware acceleration through the use of a hardware accelerator card, such as accelerator card 312 illustrated in FIG. 3.

### EXAMPLES

### Example 1

### Requesting an Interpretation of a Medical Record

A subject is informed by a treating physician of a proposed treatment strategy for the subject's condition. The subject seeks a second medical opinion, and the subject accesses an online platform of the invention. The subject creates a subject profile within the online platform of the invention, and the subject uploads the subject's electronic medical records, including the subject's case media. The subject submits a request for an interpretation of the uploaded medical record to the invention described herein.

The system and methods of the invention receive the request and assign select group members as dedicated point-of-contact support associates for the case. A computer program product of the invention searches, based on the uploaded medical record of the subject, a database of qualified health care providers that comprise qualified health care professionals proficient in providing an interpretation of a medical record. The computer program product ranks the qualified health care providers based on their specialty, the length of their expertise, medical reputation, and/or referrals by other physicians. A dedicated group member assigned to the case utilizes the computer program product of the invention to request an interpretation of the received medical record by at least one of the identified qualified health care providers.

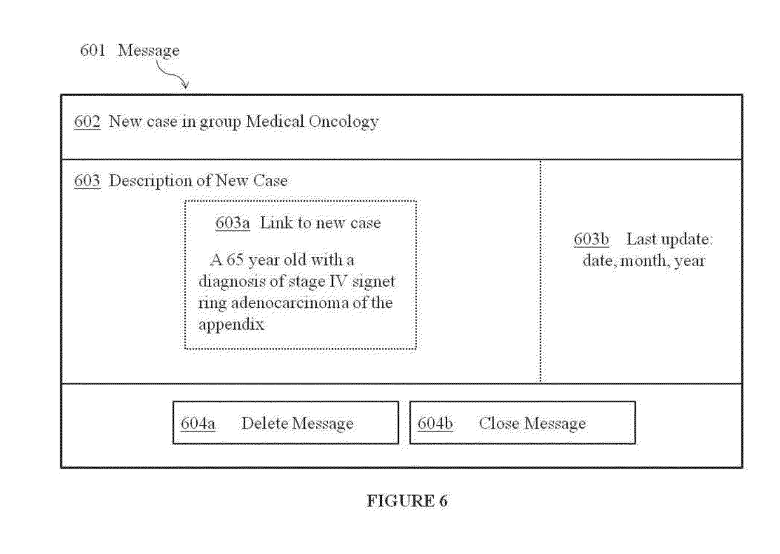

A qualified physician receives a message from a dedicated group member assigned to the invention (FIG. 6, 601) inviting the qualified physician to submit an interpretation of the medical record. The message describes a new case in a physician's group 602. The physician opens the description of the new case 603, and the physician is presented with a brief summary of the case, including the topic and scope of the request. The physician clicks on a link to the new case 603a, which forwards the physician to a secure online location within the invention comprising a more comprehensive description of the diagnosis of stage IV signet ring adenocarcinoma of the appendix in this patient. The message also provides the physician with information describing the date, month, and year of the last update by the subject 603b, and the physician can choose to delete 604a or close the message 604b.

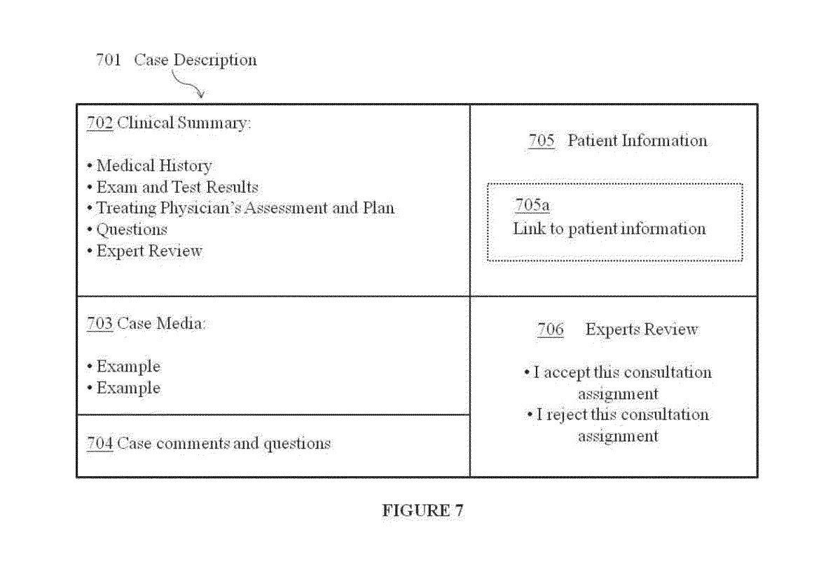

The qualified physician clicks on the link to the new case 603a describing the diagnosis of stage IV signet ring adenocarcinoma of the appendix in this patient. FIG. 7 illustrates the architecture of an online page comprising a more comprehensive case description 701 which the qualified physician has now accessed. A clinical summary 702 of the case includes all medical records, medical information, and medical history provided by the subject seeking a medical interpretation. The clinical summary 702 of the subject diagnosed with stage IV signet ring adenocarcinoma of the appendix includes the subject's medical history, exam and test results, the subject's treating physician's assessment and plan, questions from the subject, and a placeholder for reviews by at least one expert. The case media 703 for the subject diagnosed with stage IV signet ring adenocarcinoma of the appendix includes CT scans of abdomen and pelvis with contrast, CT scans of abdomen and pelvis without contrast, coronal body related media, and sagittal body related media, and information pertaining to the same. The qualified physician reviewing the request for a medical interpretation can access case comments and questions posted, for example, by the subject 704. The qualified physician reviewing the request for a medical interpretation can view a summary of patient information, including age and gender, and the qualified physician can access a link 705a comprising further patient information. Based on the case, the qualified physician can choose to provide an expert review of the case 706, or the qualified physician can choose not to provide an expert review of the case.

The qualified physician is an oncologist with extensive expertise in adenocarcimas. The qualified physician chooses to provide an expert review of the case. By accepting to review the case, the qualified physician gains access to an expert case summary 801 secure location within the website of the invention. The qualified physician is now referred to as an expert associated with case. The expert can review links to the patient's medical history 802a, exam and test results 802b, treating physicians assessment and plan 802c, questions 802d, and the qualified expert can review expert reviews provided by other qualified physicians 802e. When reviewing a case, the expert can refer to additional insight, comments, and expert opinion 802f of additional expert physicians authorized to review the particular case.

The qualified physician then proceeds to provide his assessment of the diagnosis of stage IV signet ring adenocarcinoma of the appendix in this patient 803. The qualified physician provides recommendations that include a new diagnosis, and the qualified physician proposes a different course of treatment.

### Example 2

### Modules of a Virtual Health Care System

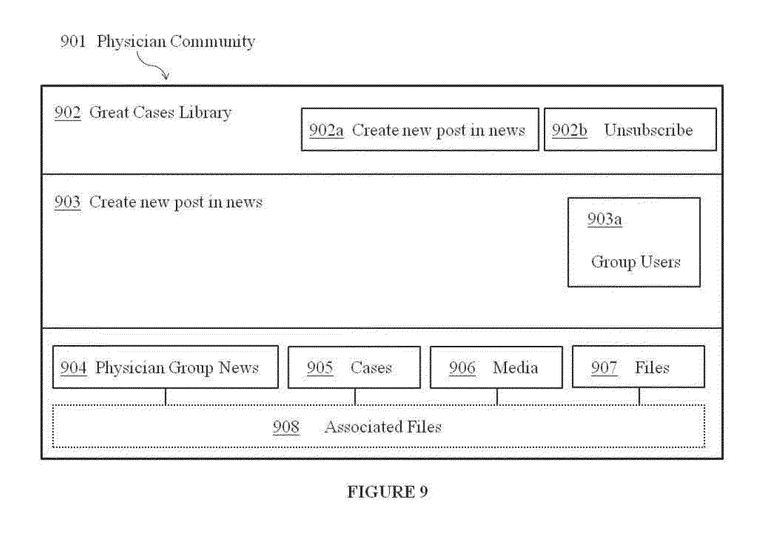

An on-line physician community is accessed from a virtual on-line community by a physician. A module of a virtual health care system is a great cases library (FIG. 9, 901). The online community provides the physician with access to an on-line location comprising a great cases library 902. The physician seeks to assess a medically relevant case in the library 902. The physician inspects the cases currently listed in the library 902. The physician seeks to create a new post about a particular case and the physician clicks an on-line link that provides the physician with the tools to create a new post 902a. The physician is interested in the cases currently comprised within the library 902, and the physician decides not to click on the unsubscribe 902b link associated with any of those cases.

The physician inputs information on the virtual location 903 that provides the physician with the tools to create a new post. The physician seeks additional feedback from peers and colleagues, and the physician chooses to make the case visible to select group users 903a. Authorized physicians and group users post comments on a physician group news 904 associated with the case, on a plurality of cases 905 associated with the library, on a plurality of case media 906 associated with the library, and on a plurality of files 907 associated with the library. Some authorized physicians and group users further provide links to associated files 908 of similar/relevant cases that can be of interest when viewed in light of the newly created post.

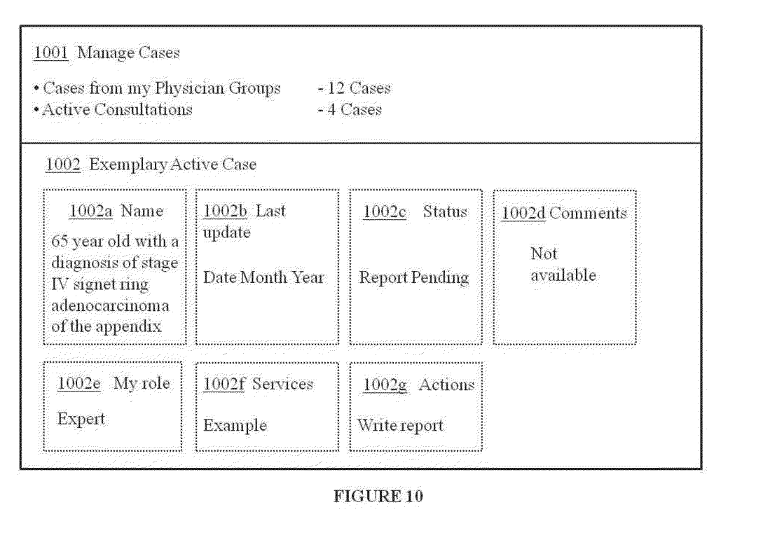

A module of a virtual health care system is a manage cases module (FIG. 10, 1001). A physician seeks to manage a request for a medical interpretation within a virtual health care system through a manage cases 1001 module. A physician accesses a manage cases module 1001 and a physician visualizes the active consultations the physician has agreed to review 1001. The physician also visualizes the active cases within the physician's group. A physician clicks on an active consultation 1001. A physician visualizes information associated with the clicked active case 1002. Information associated with the active case includes the name of the case 1002a, date of last update 1002b, status of the case 1002c, comments 1002d, physician's role 1002e, services 1002f, and actionable items 1002g. The physician sees that an actionable item requires the physician to write an expert report. The physician proceeds into writing the expert report.

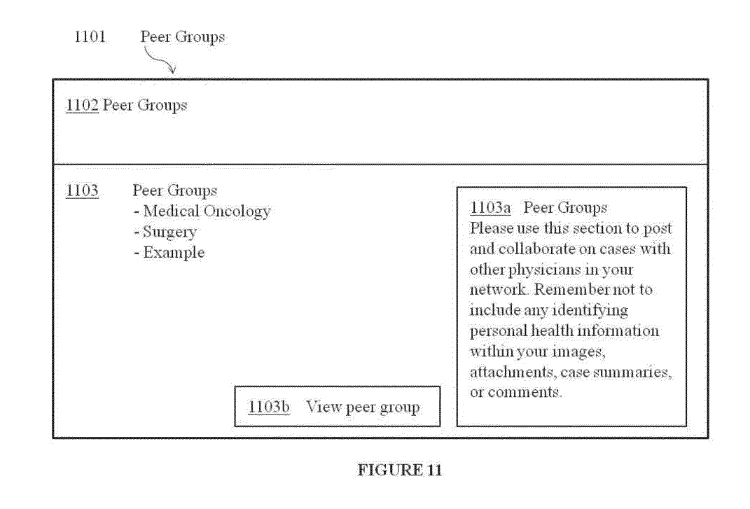

A module of a virtual health care system is a peer group module (FIG. 11, 1101). A physician seeks to interact with colleagues and peers within a virtual health care system and a physician accesses a link to a peer groups module 1102. The physician clicks on a link to a peer groups 1103 entry page and the physician visualizes descriptions posted by peers of the physician, such as a medical oncology case. The physician also visualizes comments posted by peers on a surgical case previously posted by the physician within the peer groups link 1103. Within the peer group module 1103 the physician visualizes a range of guidelines for reminders and notes 1103a that pertain to posted cases. The physician chooses to click on an additional link that allows for the visualization of a sub-group within the peer community 1103b.

### EMBODIMENTS

The following non-limiting embodiments provide illustrative examples of the invention, but do not limit the scope of the invention.

### Embodiment 1

A method of requesting an interpretation of a medical record, the method comprising: a) receiving a medical record associated with a subject by a computer system; b) searching based on the medical record a database of health care providers, wherein each healthcare provider in the database is independently associated with a specialty, to provide at least one qualified health care provider, wherein the qualified health care provider is qualified to interpret the medical record, wherein the computer system comprises a processor, wherein the search is performed by the processor; c) requesting from the qualified health care provider a requested interpretation of the medical record; d) receiving the requested interpretation of the medical record from the qualified health care provider; and e) ranking the requested interpretation against at least one alternative interpretation by a different health care provider to provide a ranking of interpretations.

### Embodiment 2

The method of Embodiment 1, wherein the qualified health care provider has an expertise associated with the medical record.

### Embodiment 3

The method of any one of Embodiments 1 and 2, wherein the requested interpretation is ranked based on a level of the expertise.

### Embodiment 4

The method of any one of Embodiments 1-3, wherein the requested interpretation is based on virtual collaboration among the qualified health care provider and an additional health care provider.

### Embodiment 5

The method of any one of Embodiments 1-4, wherein the qualified health care provider and the additional health care provider are anonymous to one another.

### Embodiment 6

The method of any one of Embodiments 1-5, wherein the interpretation of the medical record comprises a diagnosis.

### Embodiment 7

The method of any one of Embodiments 1-6, wherein the interpretation of the medical record comprises a treatment recommendation.

### Embodiment 8

The method of any one of Embodiments 1-7, wherein the interpretation of the medical record comprises a review of a diagnosis to provide a second opinion.

### Embodiment 9

The method of any one of Embodiments 1-8, wherein the interpretation of the medical record comprises a review of a treatment recommendation to provide a second opinion.

### Embodiment 10

The method of any one of Embodiments 1-9, further comprising providing access to the ranking of interpretations to a user.

### Embodiment 11

The method of any one of Embodiments 1-10, wherein the medical record comprises a condition, and wherein upon receiving the requested interpretation from the qualified health care provider, the computer system places the qualified health care provider on a queue to receive future health care requests associated with the condition.

### Embodiment 12

The method of any one of Embodiments 1-11, further comprising searching a database of medical resources based on an information in the medical record, thereby identifying a relevant medical resource, and providing the relevant medical resource to the qualified health care provider upon requesting the requested interpretation.

### Embodiment 13

The method of Embodiment 12, wherein the relevant medical resource is added to an on-line personal medical profile of the subject.

### Embodiment 14

The method of any one of Embodiments 1-13, further comprising soliciting from a physician a second opinion of the ranking of interpretations.

### Embodiment 15

The method of any one of Embodiments 1-14, further comprising providing access to the medical record and the requested interpretation to an on-line community of physicians over a virtual network.

### Embodiment 16

The method of any one of Embodiments 1-15, wherein the medical record is received via a health care request from the subject.

### Embodiment 17

The method of any one of Embodiments 1-16, wherein the medical record is received from an on-line personal medical profile of the subject.

### Embodiment 18

The method of any one of Embodiments 1-17, wherein the medical record comprises a preliminary diagnosis.

### Embodiment 19

The method of any one of Embodiments 1-18, wherein the searching identifies a plurality of qualified health care providers, and each qualified health care provider of the plurality is ranked to provide a ranked set of qualified health care providers ordered from a highest rank to a lowest rank.

### Embodiment 20

The method of Embodiment 19, wherein the requesting comprises querying the qualified health care providers in the ranked set in an order beginning with the qualified health care provider with the highest rank.

### Embodiment 21

The method of any one of Embodiments 19 and 20, wherein the requesting comprises querying the qualified health care providers in the ranked set in a random order.

### Embodiment 22

The method of any one of Embodiments 1-21, wherein a qualified health care provider is queried after at least one other qualified health care provider replied to the request affirmatively.

### Embodiment 23

The method of any one of Embodiments 1-22, further comprising providing to the subject a therapeutic intervention associated with the requested interpretation.

### Embodiment 24

A computer program product comprising a computer-readable medium having computer-executable code encoded therein, the computer-executable code adapted to be executed to implement a method comprising: a) providing a virtual health care system, wherein the virtual health care system comprises: i) an input module; ii) a database, wherein the database comprises a plurality of health care providers; iii) a search module; iv) a ranking module; v) a request module; and vi) an output module; b) receiving an electronic medical record from a user by the input module, whereupon the input module transmits information from the medical record to the search module; c) searching, based on the information, the database by the search module, whereby the search module identifies in the database a subset of health care providers associated with the information; d) ranking by the ranking module the subset of health care providers, whereby the ranking module ranks each health care provider in the subset of health care providers based on a level of association with the information to provide a set of ranked health care providers; e) requesting by the request module a requested interpretation of the medical record from at least one of the ranked health care providers; f) receiving by the request module at least one requested interpretation; g) ranking by the ranking module the received requested interpretation against at least one alternative interpretation to provide a set of ranked interpretations; and h) outputting the set of ranked interpretations via the output module.

### Embodiment 25

The computer program product of Embodiment 24, wherein each health care provider in the subset of health care providers associated with the information of step c) is independently associated with the information based on a specialty.

### Embodiment 26

The computer program product of any one of Embodiments 24 and 25, wherein the ranking of the set of ranked interpretations of step g) correlates to the ranking of the set of ranked health care providers.

### Embodiment 27

The computer program product of any one of Embodiments 24-25, wherein the virtual health care system of step a) further comprises a database of medical resources and a medical resource search module, wherein the medical resource search module searches the database of medical resources based on the information to identify a relevant medical resource, wherein the relevant medical resource is provided to the ranked health care provider in the requesting by the request module.

### Embodiment 28

The computer program product of any one of Embodiments 24-26, wherein the virtual health care system further comprises an on-line portal, wherein the on-line portal provides an on-line community with access to the medical record.

### Embodiment 29

The computer program product of Embodiment 28, wherein the online community comprises a subset of physicians.

### Embodiment 30

The computer program product of any one of Embodiment 28 and 29, wherein the virtual health care system further comprises a medical imaging module, wherein the medical imaging module provides the on-line community with access to medical images associated with the medical record.

What is claimed is:

1. A method of requesting an interpretation of a medical record, the method comprising:
a) receiving a medical record associated with a subject by a computer system;
b) searching based on the medical record a database of health care providers, wherein each healthcare provider in the database is independently associated with a specialty, to provide at least one qualified health care provider, wherein the qualified health care provider is qualified to interpret the medical record, wherein the computer system comprises a processor, wherein the search is performed by the processor;
c) requesting from the qualified health care provider a requested interpretation of the medical record;
d) receiving the requested interpretation of the medical record from the qualified health care provider; and
e) ranking the requested interpretation against at least one alternative interpretation by a different health care provider to provide a ranking of interpretations.

2. The method of claim 1, wherein the qualified health care provider has an expertise associated with the medical record.

3. The method of claim 2, wherein the requested interpretation is ranked based on a level of the expertise.

4. The method of claim 1, wherein the requested interpretation is based on virtual collaboration among the qualified health care provider and an additional health care provider.

5. The method of claim 4, wherein the qualified health care provider and the additional health care provider are anonymous to one another.

6. The method of claim 1, wherein the requested interpretation of the medical record comprises a diagnosis.

7. The method of claim 1, wherein the interpretation of the medical record comprises a treatment recommendation.

8. The method of claim 1, wherein the interpretation of the medical record comprises a review of a diagnosis to provide a second opinion.

9. The method of claim 1, wherein the interpretation of the medical record comprises a review of a treatment recommendation to provide a second opinion.

10. The method of claim 1, further comprising providing access to the ranking of interpretations to a user.

11. The method of claim 1, wherein the medical record comprises a condition, and wherein upon receiving the requested interpretation from the qualified health care provider, the computer system places the qualified health care provider on a queue to receive future health care requests associated with the condition.

12. The method of claim 1, further comprising searching a database of medical resources based on an information in the medical record, thereby identifying a relevant medical resource, and providing the relevant medical resource to the qualified health care provider upon requesting the requested interpretation.

13. The method of claim 12, wherein the relevant medical resource is added to an on-line personal medical profile of the subject.

14. The method of claim 1, further comprising soliciting from a physician a second opinion of the ranking of interpretations.

15. The method of claim 1, further comprising providing access to the medical record and the requested interpretation to an on-line community of physicians over a virtual network.

16. The method of claim 1, wherein the medical record is received via a health care request from the subject.

17. The method of claim 1, wherein the medical record is received from an on-line personal medical profile of the subject.

18. The method of claim 1, wherein the medical record comprises a preliminary diagnosis.

19. The method of claim 1, wherein the searching identifies a plurality of qualified health care providers, and each qualified health care provider of the plurality is ranked to provide a ranked set of qualified health care providers ordered from a highest rank to a lowest rank.

20. The method of claim 19, wherein the requesting comprises querying the qualified health care providers in the ranked set in an order beginning with the qualified health care provider with the highest rank.

21. The method of claim 19, wherein the requesting comprises querying the qualified health care providers in the ranked set in a random order.

22. The method of claim 19, wherein a qualified health care provider is queried after at least one other qualified health care provider replied to the request affirmatively.

23. The method of claim 1, further comprising providing to the subject a therapeutic intervention associated with the requested interpretation.

24. A computer program product comprising a computer-readable medium having computer-executable code encoded therein, the computer-executable code adapted to be executed to implement a method comprising:
a) providing a virtual health care system, wherein the virtual health care system comprises:
i) an input module;
ii) a database, wherein the database comprises a plurality of health care providers;
iii) a search module;
iv) a ranking module;
v) a request module; and
vi) an output module;
b) receiving an electronic medical record from a user by the input module, whereupon the input module transmits information from the medical record to the search module;
c) searching, based on the information, the database by the search module, whereby the search module identifies in the database a subset of health care providers associated with the information;
d) ranking by the ranking module the subset of health care providers, whereby the ranking module ranks each health care provider in the subset of health care providers based on a level of association with the information to provide a set of ranked health care providers;
e) requesting by the request module a requested interpretation of the medical record from at least one of the ranked health care providers;
f) receiving by the request module at least one requested interpretation;
g) ranking by the ranking module the received requested interpretation against at least one alternative interpretation to provide a set of ranked interpretations; and
h) outputting the set of ranked interpretations via the output module.

25. The computer program product of claim 24, wherein each health care provider in the subset of health care providers associated with the information of step c) is independently associated with the information based on a specialty.

26. The computer program product of claim 24, wherein the ranking of the set of ranked interpretations of step g) correlates to the ranking of the set of ranked health care providers.

27. The computer program product of claim 24, wherein the virtual health care system of step a) further comprises a database of medical resources and a medical resource search module, wherein the medical resource search module searches the database of medical resources based on the information to identify a relevant medical resource, wherein the relevant medical resource is provided to the ranked health care provider in the requesting by the request module.

28. The computer program product of claim 24, wherein the virtual health care system further comprises an on-line portal, wherein the on-line portal provides an on-line community with access to the medical record.

29. The computer program product of claim 28, wherein the online community comprises a subset of physicians.

30. The computer program product of claim 28, wherein the virtual health care system further comprises a medical imaging module, wherein the medical imaging module provides the on-line community with access to medical images associated with the medical record.
